(19) United States
(12) Patent Application Publication
(10) Pub. No.: US 2011/0096547 A1
(43) Pub. Date: Apr. 28, 2011

(54) TWIN BEAM THEATRICAL LIGHT WITH RADIAL LENTICULAR HOMOGENIZING LENS

(76) Inventors: Richard S. Belliveau, Austin, TX (US); Michael Bell, Austin, TX (US); Joe Shelton Williamson, III, Austin, TX (US)

(21) Appl. No.: 12/985,377

(22) Filed: Jan. 6, 2011

Related U.S. Application Data
(63) Continuation of application No. 12/256,613, filed on Oct. 23, 2008, now Pat. No. 7,887,219.

(51) Int. Cl. F21S 8/00; F21V 7/00

(52) U.S. Cl. 362/277; 362/296.01

(57) ABSTRACT

A theatre lighting apparatus comprising a base, a communications port, a processor, a memory, and a lamp housing is disclosed. The lamp housing may include a lamp, a reflector, an output lens, a motor, and a homogenizing lens. The homogenizing lens may be comprised of a plurality of radially arranged lenticular lenses. The processor may be programmed to enable a motor to vary a position of the homogenizing lens in relation to a position of the output lens. The homogenizing lens may be comprised of a first half and a second half, each of which may have a plurality of radially arranged lenticular lenses.

### CROSS REFERENCE TO RELATED APPLICATION(S)

The present application is a continuation of and claims the priority of U.S. patent application Ser. No. 12/256,613, titled “TWIN BEAM THEATRICAL LIGHT WITH RADIAL LENTICULAR HOMOGENIZING LENS”, filed on Oct. 23, 2008.

### FIELD OF THE INVENTION

This invention relates to multiparameter lighting fixtures.

### BACKGROUND OF THE INVENTION

Multiparameter lighting fixtures are lighting fixtures, which illustratively have two or more individually remotely adjustable parameters such as focus, color, image, position, or other light characteristics. Multiparameter lighting fixtures are widely used in the lighting industry because they facilitate significant reductions in overall lighting system size and permit dynamic changes to the final lighting effect. Applications and events in which multiparameter lighting fixtures are used to great advantage include showrooms, television lighting, stage lighting, architectural lighting, live concerts, and theme parks. Illustrative multi-parameter lighting fixtures are described in the product brochure showing the High End Systems product line for the year 2000 and are available from High End Systems, Inc. of Austin, Tex.

Multiparameter lighting fixtures are commonly constructed with a lamp housing that may pan and tilt in relation to a base housing so that light projected from the lamp housing can be remotely positioned to project on the stage surface. Commonly a plurality of multiparameter lights are controlled by an operator from a central controller. The central controller is connected to communicate with the plurality of multiparameter lights via a communication system. U.S. Pat. No. 4,392,182 titled “Computer controlled lighting system having automatically variable position, color, intensity and beam divergence” to Bornhorst and incorporated herein by reference, disclosed a plurality of multiparameter lights and a central controller.

The lamp housing of the multiparameter light contains the optical components and the lamp. The lamp housing is rotatably mounted to a yoke that provides for a tilting action of the lamp housing in relation to the yoke. The lamp housing is tilted in relation to the yoke by a motor actuator system that provides remote control of the tilting action by the central controller. The yoke is rotatably connected to the base housing that provides for a panning action of the yoke in relation to the base housing. The yoke is panned in relation to the base housing by a motor actuator system that provides remote control of the panning action by the central controller.

A lamp and reflector are used in combination to produce a light path for a theatrical light. It is desirable to have a field of light produced by the theatrical light that does not have artifacts from the lamp image in the projected light. Various means to reduce artifacts in the prior art include facets placed into the reflector, diffusion glass placed into the light path and fly's eye homogenizing lenses. For example the present inventor discloses in U.S. Pat. No. 6,048,080 to Belliveau a lenticular array of lens elements for variably shaping a beam of a theatrical light. The Bornhorst '182 patent previously mentioned above discloses an integrating lens 100 formed of a large number of small spherical lens 102 mounted on a flat transparent substrate which acts to homogenize light.

The present inventor's pending patent application Ser. No. 11/516,822, filed on Sep. 7, 2006 discloses a multiparameter theatrical light that incorporates a polymer fresnel output lens to reduce lens weight. This type of lens uses micro lenslets to form the optical power of the lens. Because of the size and frequency of the micro lenslets the polymer fresnel lens is quite transparent to the eye. When a fly's eye homogenizing lens (such as the integrating lens 100 of U.S. patent to Bornhorst '182) is placed in a light path of a theatrical light incorporating a polymer fresnel output lens in the location before the polymer fresnel lens, the honeycomb pattern of a fly's eye homogenizing lens can be easily seen from the outside of the theatrical light. Most prior art theatrical spotlights employ radially designed glass Fresnel lenses as output lenses. An example of this incorporated herein is the Altman 65Q catalog page from Altman Stage Lighting of Yonkers, N.Y.

It is desirable during the presentation of a theatrical light incorporating a polymer fresnel lens to avoid displaying a honeycomb pattern from a fly's eye homogenizing lens as seen through the polymer Fresnel lens. It is desirable to construct a homogenizing lens that does an excellent job of homogenizing while still retaining a radial like visible pattern created by the homogenizing lens.

Effects using various prism types have been used in the prior art with automated theatrical lights. Prism effects can increase the value of an automated theatrical light by augmenting the image varying capability of the light. It would be therefore be desirable to create a new prism effect for an automated theatrical light that has a new dynamic look that can be adjusted by an operator of the theatrical light.

### SUMMARY OF THE INVENTION

One or more embodiments of the present invention provide a theatre lighting apparatus comprising a base, a communications port, a processor, a memory, and a lamp housing. The lamp housing may include or have located therein a lamp, a reflector, an output lens, a motor, and a homogenizing lens. The homogenizing lens may be comprised of a plurality of radially arranged lenticular lenses. The processor may be programmed to enable a motor to vary a position of the homogenizing lens in relation to a position of the output lens. In at least one embodiment, the communications port receives a command, provides it to the processor, and the processor in response to the command is programmed to cause the motor to vary the position of the homogenizing lens in relation to the position of the output lens. The output lens may be a polymer fresnel lens.

In at least one embodiment, a light path may be created by the lamp and the reflector. The homogenizing lens may be comprised of a first half and a second half, such that the first half is independent of the second half. Each of the first half and the second half may have a plurality of radially arranged lenticular lenses. The processor may be programmed to cause a first motor to tilt the first half in or out of the light path. The processor may be programmed to cause a second motor to tilt the second half in or out of the light path. The processor may be programmed to cause the first motor to tilt the first half into the light path in response to a first command received by the communications port and provided to the processor. The processor may be programmed to cause a motor to vary a position of the homogenizing lens in relation to the reflector.

In one or more embodiments a prism apparatus may be provided. A first light path having an optic axis may be created by the lamp and the reflector. The prism apparatus may be comprised of a plurality of substantially parallel linear triangular prisms. Each of the plurality of prisms has a first side for receiving light from the first light path, a second side for exiting refracted light received from the first light path towards a first direction forming a second light path, and a third side for exiting refracted light received from the first light path towards a second direction forming a third light path. The first direction and the second light path may be at a substantially negative deviation angle in relation to the axis of the first light path and the second direction and third light path may be at a substantially positive deviation angle in relation to the axis of the first light path.

The processor may be programmed to cause a motor to position the prism apparatus to a first position in relation to the output lens along the first light path to obtain a first deviation angle for the second light path and obtain a second deviation angle for the third light path. The processor may be programmed to cause the motor to position the prism apparatus to a second position in relation to the output lens along the first light path to obtain a third deviation angle for the second light path and obtain a fourth deviation angle for the third light path.

The deviation angles of the second light path and the third light path may be remotely controlled by a command received by the communications port and provided to the processor.

The prism apparatus may be comprised of a plurality of Isosceles prisms. The processor may be programmed to cause the motor to rotate the prism apparatus about the axis of the prism apparatus in response to a command received by the communication port and provided to the processor. The processor may be programmed to cause the motor to position the prism apparatus in relationship to the output lens along the first light path in response to a command received by the communication port and provided to the processor.

### BRIEF DESCRIPTION OF THE DRAWINGS

FIG. 1 shows a front view of a theatrical light in accordance with an embodiment of the present invention;

FIG. 2A shows a a front view of a radial lenticular homogenizing lens of an embodiment of the present invention;

FIG. 2B shows a front view of a prism apparatus of an embodiment of the present invention;

FIG. 2C shows a side view of the prism apparatus of FIG. 2B;

FIG. 3A shows an internal view of components of a lamp housing of the theatrical light of FIG. 1 incorporating the radial lenticular homogenizing lens of FIG. 2A in a first state and the prism apparatus of FIG. 2B in a first state;

FIG. 3B shows an internal view of the components of the lamp housing of the theatrical light of FIG. 1 incorporating the radial lenticular homogenizing lens of FIG. 2A in a second state and the prism apparatus of FIG. 2B in a first state;

FIG. 3C shows an internal view of the components of the lamp housing of the theatrical light of FIG. 1 incorporating the radial lenticular homogenizing lens of FIG. 2A in a third state and showing the prism apparatus of FIG. 2B in a second state;

FIG. 3D shows an internal view of the components of the lamp housing of the theatrical light of FIG. 1 incorporating the radial lenticular homogenizing lens of FIG. 2A in a third state and showing the prism apparatus of FIG. 2B in a third state; and

FIG. 4 shows an internal view of components of a base housing of the theatrical light of FIG. 1.

### DETAILED DESCRIPTION OF THE DRAWINGS

In the description that follows, like parts are marked throughout the specification and drawings with the same reference numerals, respectively. The drawing figures are not necessarily to scale. Certain features of embodiments of the present invention may be shown exaggerated in scale or in somewhat schematic form and some details of conventional elements may not be shown in the interest of clarity and conciseness. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce the desired results.

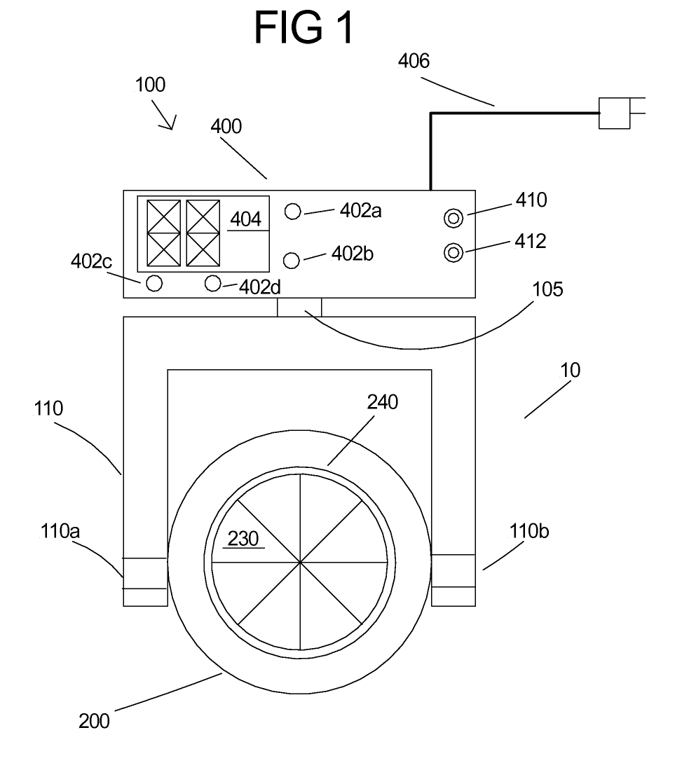

FIG. 1 shows a front view of a theatrical light, theatre light, or theatre lighting apparatus 100 in accordance with an embodiment of the present invention. The theatrical light 100 may be a multiparameter lighting device. The theatrical light 100 includes a lamp housing 300 and a base housing 400. The theatrical light 100 is capable of remotely panning and tilting the lamp housing 300 in relation to the base housing 400. The lamp housing 300 is mounted by bearing assemblies 110a and 110b so that the lamp housing 300 can tilt in relation to a yoke 110. The yoke 110 can pan in relation to the base housing 400 by means of a bearing 105. The lamp housing 300 is remotely tilted in relation to the base housing 400 by a first motor actuator not shown for simplicity. The yoke 110 is remotely panned in relation to the base housing 400 by a second motor actuator not shown for simplicity.

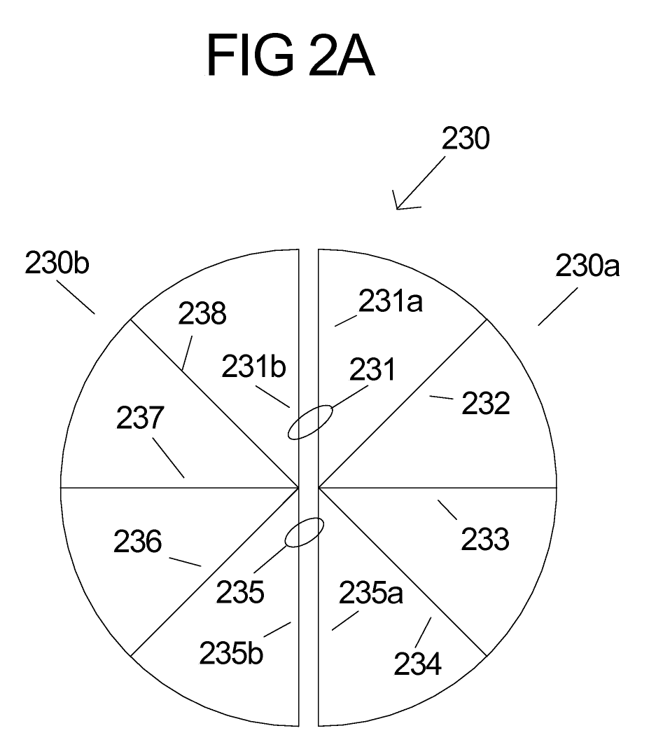

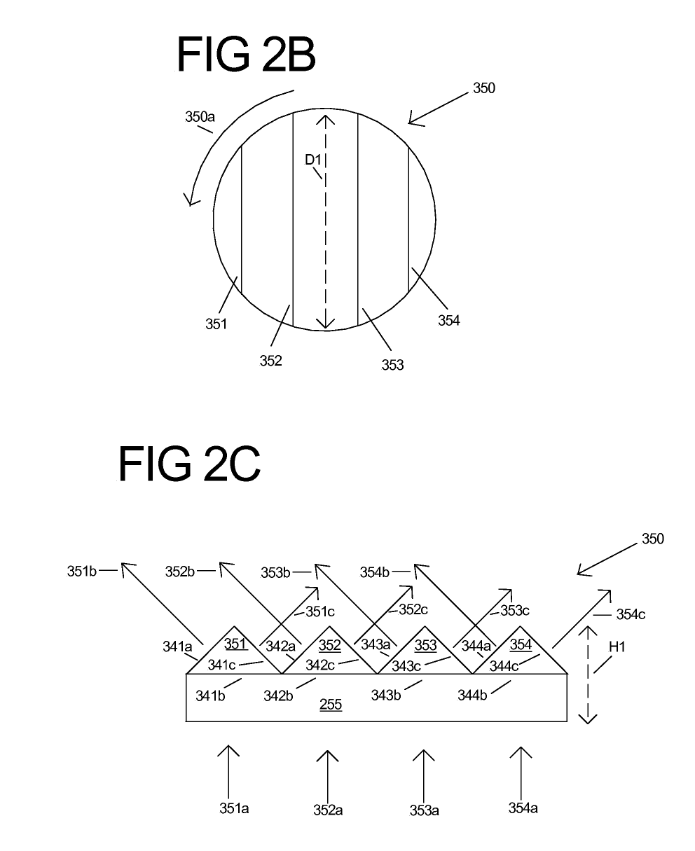

The lamp housing 300 includes, or has located therein, an output lens 340. The output lens 340 may be a polymer fresnel lens and typically is the main output lens of the lamp housing 300. The polymer Fresnel lens 340 is optically transparent to the eye. A radial lenticular homogenizing lens 330 as described by FIG. 2A is viewable through the optically transparent polymer Fresnel lens 340.

The base housing 400 has a graphical display 404 and input keys 402a, 402b, 402c and 402d used for setting a communications address as well as controlling other functions of the theatrical light 100. The theatrical light 100 also includes a power input cord 406 for connecting the theatrical light 100 to a source of power. The theatrical light 100 also includes connection points 410 and 412, one of which is an input connector and one of which is an output connector.

FIG. 2A shows a detailed drawing of a front view of the radial lenticular homogenizing lens 230. The radial lenticular lens 230 is shown as two half sections 230a and 230b however the radial lenticular lens 230 may be a single lens without the splitting of the two sides. The radial lenticular lens 230, as shown in FIG. 2A includes eight lenticular lenses or lens sections 231, 232, 233, 234, 235, 236, 237 and 238 arranged in a radial pattern. Each lenticular lens of lenses 231-238, is a section or pie slice of the overall substantially circular radial lenticular lens 230. In FIG. 2A, the lead lines from the numbers 231-238 point to lines which represent apexes of the lenticular lenses 231-238, respectively.

While eight lenticular lenses or sections 231-238 are shown to construct radial lenticular lens 230 more or less lenticular lens sections or elements may be used to form the radial lenticular homogenizing lens 230. Lenticular lens or section 231 is actually bisected into two halves to accommodate the splitting of the lens 230 into half sections 230a and 230b and the bisection lines are shown as lines 231a and 231b. Lenticular lens 235 is actually bisected into two halves to accommodate the splitting of the lens 230 into half sections 230a and 230b and the bisection lines are shown as lines 235a and 235b. Because each of the eight lenticular lenses or lens sections 231-238 of the radial lenticular homogenizing lens 230 have an optical power, the radial lenticular lens 230 has an overall homogenized optical power. Because the radial lenticular lens 230 has an optical power it can be remotely positioned in relation to the polymer Fresnel output lens 240 shown in FIG. 1 to provide a controllable zoom for the theatrical light 100 of FIG. 1.

FIG. 2B shows a front view of a prism apparatus 350 that is constructed of linear isosceles prisms 351, 352, 353 and 354 that run parallel to each other. Arrow 350a shows that the prism apparatus 350 can also be rotated in a direction about its center by a motor when used as a component of the theatrical light 100.

FIG. 2C shows a side view of the prism apparatus 350. The prism apparatus 350 may be constructed of the plurality of prisms 351, 352, 353, and 354, mounted to a substrate 355 or the plurality of prisms 351-354 and the substrate 355 may be molded together to form the prism apparatus 350. It is preferred that the prism apparatus 350 be molded as one overall component. In operation incoming light rays shown as arrow 351a passes thought the substrate 355 and through the base 341b of the prism 351 where a first portion of light rays 351a is refracted into a first direction shown by arrow 351b exiting from side 341a and a second portion of light rays 351a is refracted into a second direction shown by arrow 351c exiting from side 341c. Light rays shown as arrow 352a passes thought the substrate 355 and through the base 342b of the prism 352 where a first portion of light rays 352a is refracted into a first direction shown by arrow 352b exiting from side 342a and a second portion of light rays 352a is refracted into a second direction shown by arrow 352c exiting from side 342c. Light rays shown as arrow 353a passes thought the substrate 355 and through the base 343b of the prism 353 where a first portion of light rays 353a is refracted into a first direction shown by arrow 353b exiting from side 343a and a second portion of light rays 353a is refracted into a second direction shown by arrow 353c exiting from side 343c. Light rays shown as arrow 354a passes thought the substrate 355 and through the base 344b of the prism 354 where a first portion of light rays 354a is refracted into a first direction shown by arrow 354b exiting from side 344a and a second portion of light rays 354a is refracted into a second direction shown by arrow 354c exiting from side 344c. Isosceles prisms are used with prism apparatus 350 because it is preferred that the rays exiting the prism apparatus 350 exit in two equal but opposite angles. However a prism beam splitting assembly can be produced with exiting angles are not equal and therefore prisms that are not of the isosceles type.

In FIG. 2B, the lead lines from the numbers 351-354 point to vertical lines which represent the apexes of the prisms 351-354, respectively. In FIG. 2C the apexes of the prisms 351-354 are at the top of the prisms 351-354.

The prism apparatus 350 of FIG. 2B in practice can have a diameter D1 which may be three inches. One or more embodiments of the present invention allow the overall height, H1, shown in FIG. 2C of the prism apparatus 350 to be reduced as greater numbers of individual linear prisms are placed together. The prism apparatus 350 may be comprised of any number of linear prisms similar to linear prisms 351-354.

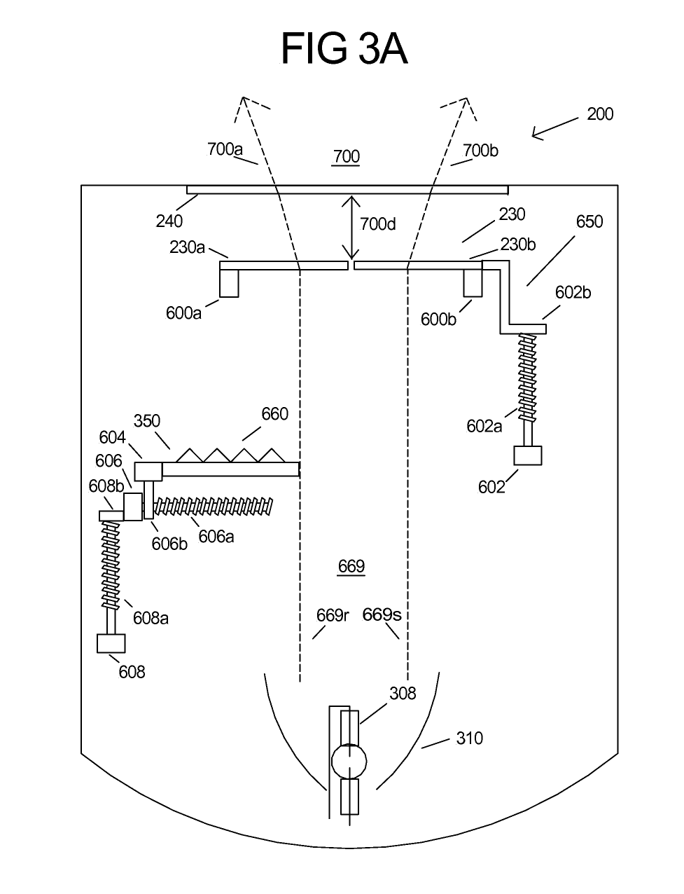

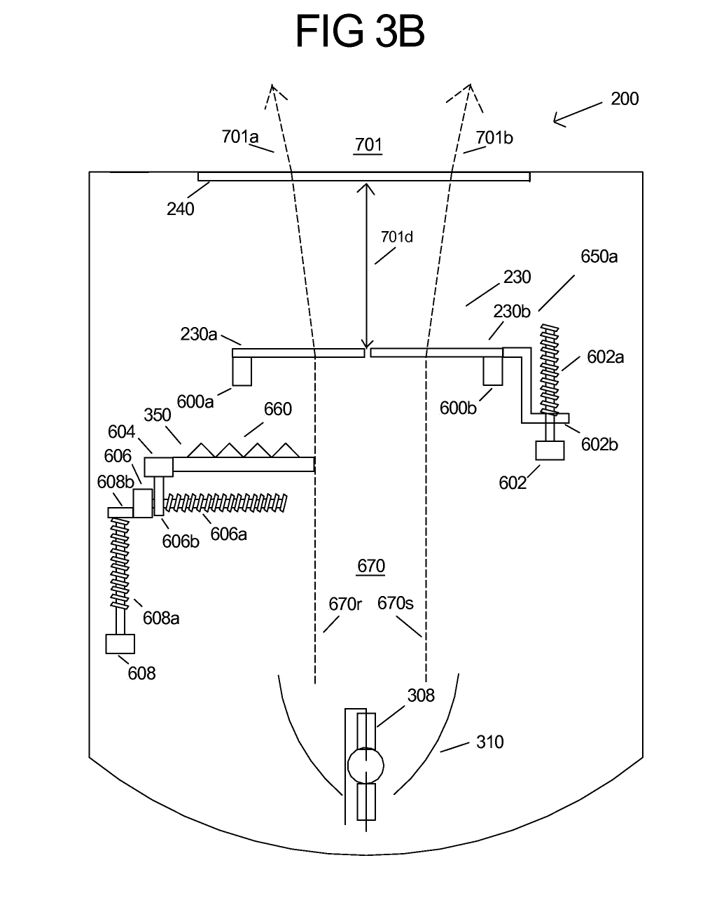

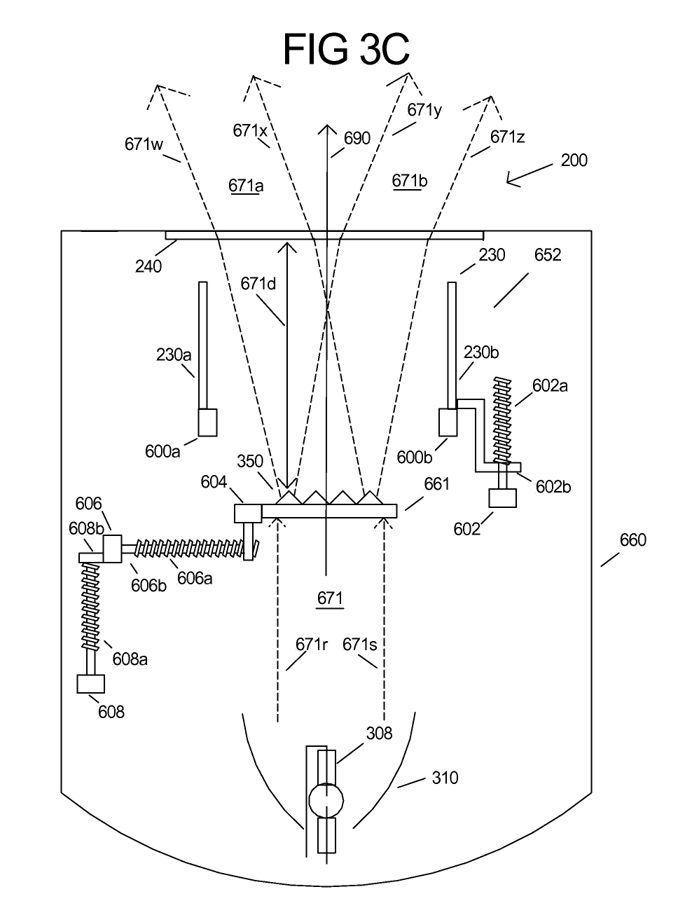

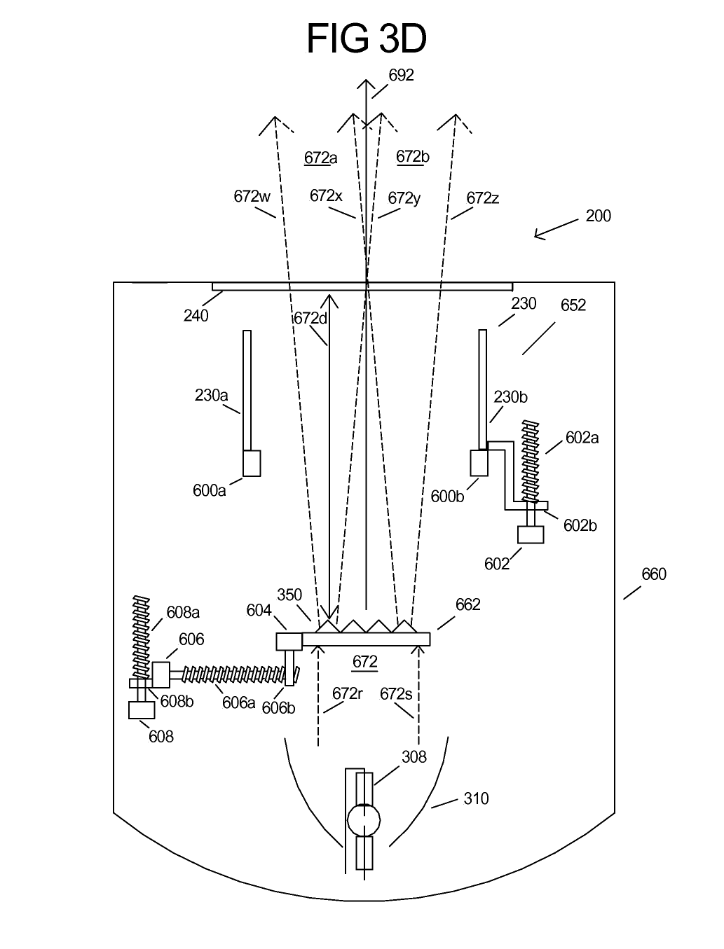

FIG. 3A shows internal components of the lamp housing 200 of FIG. 1. A polymer Fresnel output lens 240 is shown. The radial lenticular lens 230 is shown divided into the two half sections 230a and 230b. A motor 600a is attached to pivot the radical lenticular lens half 230a and motor 600b is shown for pivoting radial lenticular lens half 230b. A motor 602 controls the placement of the radial lenticular lens 230 in relation to the output lens 240 by way of a lead screw 602a and attachment bracket 602b. The radial lenticular lens system 650 which may be comprised of components 230, 230a, 230b, 600a, 600b, 602b, 602a and 602 is shown in a first state. The prism apparatus 350 is shown attached to a rotation motor 604. The rotation motor 604 is capable of rotating the prism apparatus 350 about its center as show by 350a of FIG. 2B. The prism apparatus 350 and motor 604 of FIG. 3A are attached to lead screw bracket 606b, lead screw 606a and driving motor 606 so the prism apparatus 350 can be transitioned into a light path 669 formed delimited by arrows 669r and 669s, the light of the light path 669 created by a lamp 308 and a reflector 310. The combination of the radial lenticular lens 330 and the polymer fresnel lens 240 at distance shown by arrows 700d results in an exiting light path 700 as shown by arrows 700a and 700b. Driving motor 606 is also connected to lead screw bracket 608b, lead screw 608a and motor 608 for placement of the prism apparatus 350 in relation to the output lens 340.

Prism apparatus 350, motor 604, bracket 606b, lead screw 606a, motor 606, bracket 608b, lead screw 608a and motor 608 are shown in a first state 660 in relation to the light path 669.

FIG. 3B shows internal components of the lamp housing 200 of FIG. 1. The radial lenticular lens system 650a may be comprised of components 230, 230a, 230b, 600a, 600b, 602b, 602a and 602, and the radial lenticular lens system 650a is shown in a second state. Driving motor 602 has operated the lead screw 602a to move the bracket 602b and the radial lenticular lens system 230 to a distance further from the polymer output lens 240 as shown by arrows 701d. The combination of the radial lenticular lens 230 and the polymer fresnel lens 240 at the distance shown by arrows 701d results in exiting light path 701 as shown by arrows 701a and 701b. The exiting light path 701 of FIG. 3B is at a narrower angle than the exiting light path 700 of FIG. 3A. Changing the distance between the radial lenticular lens 230 in relation to the polymer Fresnel lens 240 shown as arrows 701d results in a change of the exiting light path angle which can also be called a zoom control of the exiting light path. As shown changing the distance between the radial lenticular lens 230 in relation to the polymer Fresnel lens 240 also changes the distance relationship of the radial lenticular lens 230 in relation to the reflector 310.

FIG. 3C shows the radial lenticular lens 230 in a third state 652. The radial lenticular lens system 230 has had each half section 230a and 230b tilted out of the second light path 671a and the third light path 671b by corresponding motors 230a and 230b. Second light path 671a is shown by arrows 671w and 671x and third light path 671b is shown by arrows 671y and 671z. The prism apparatus 350 has been positioned into the first light path 671 at a distance 671d from the polymer Fresnel lens 240 by motor 606, lead screw 606a and bracket 606b. First light path 671 is shown by arrows 671r and 671s. Arrow 690 represents the center axis of the first light path 671 created by the lamp 308 and the reflector 310. Light from the first light path 671 enters the prism apparatus 350 and exits the prism apparatus 350 as a second light path 671a and a third light path 671b. Second light path 671a exits the theatrical light 100 in a negative angular deviation in relation to 690 and third light path 671b exits the theatrical light 100 in a positive angular deviation in relation to the center axis 690 of the first light path 671.

Prism apparatus 350, motor 604, bracket 606b, lead screw 606a, motor 606, bracket 608b, lead screw 608a and motor 608 are shown in a second state 661 of FIG. 3C with prism apparatus 350 positioned in the light path 671. This second state 661 differs from the first state 660 shown in FIG. 3B where the prism apparatus 350 is positioned out of the light path 670.

FIG. 3D shows the radial lenticular lens 230 in a third state 652 the same as in FIG. 3C. The prism apparatus 350 of FIG. 3D is now shown in a third state 662. The prism lens 350 has been positioned further away at a distance 672d from the polymer fresnel lens 240 by motor 608, lead screw 608a and bracket 608b. First light path 672 is formed by the lamp 308 and the reflector 310. The first light path 672 is shown by arrows 672r and 672s.

Arrow 692 represents the center axis of the first light path 672. Light from the first light path 672 enters the prism apparatus 350 and exits the prism apparatus 350 as a second light path 672a and a third light path 672b. Second light path 672a exits the theatrical light 100 in a negative angular deviation in relation to the center axis 692 of the first light path 672 and the third light path 672b exits the theatrical light 100 in a positive angular deviation in relation to the center axis 692.

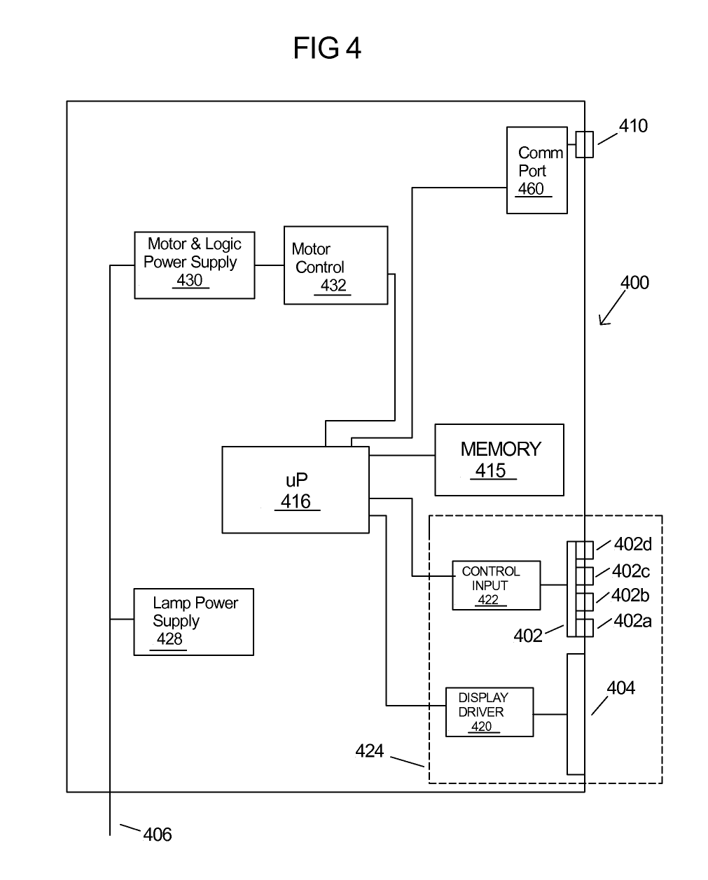

With the prism apparatus 350 of FIG. 3D positioned further away by the distance shown as 672d from the polymer fresnel lens 240 the angular deviation of the second light path 672a and the third light path 672b in relation to the center axis 692 of the first light path 672 of FIG. 3D is less angular deviation than the angular deviation of the second light path 671a and the third light path 671b in relation to the center axis 690 of FIG. 3C. As can be seen by FIGS. 3C and 3D when the prism apparatus 350 is positioned closer to the polymer Fresnel lens 240 the angular deviation of the second and third light paths that exit the polymer Fresnel lens 240 is increased. When the prism apparatus 350 is positioned further away from the polymer Fresnel lens 240 the angular deviation of the second and third light paths that exit the polymer Fresnel lens 240 decreases. The produces a very desirable effect for the theatrical light 100 as an operator remotely controlling the theatrical light 100 of the invention can send a first command to produce two substantially separate exiting beams of light (referred to as twin beams) and also send a second command to control the angular deviation of the two separate beams of light. As explained above the motor 604 can rotate the prism apparatus 350, such as in the direction 350a shown in FIG. 2B while the prism apparatus 350 is positioned in the path of the light created by the lamp 308 and the reflector 310. A third command send over a communication system and received by the communications port 460 via the input connection point 410 of the theatrical light 100 can cause the prism apparatus 350 to rotate in a way as shown by arrow 350a of FIG. 2A. In this way the two twin beams of light can have both angular deviation and rotation remotely controlled. The command sent by the operator of a remote control console and received by the communications port 460 of FIG. 4 can be compatible with the known DMX theatrical communications protocol.

FIG. 4 shows a block diagram of the components of the base housing 400. Power is supplied to the base housing 400 through an input cable or cord 406. A lamp power supply 428 supplies power to the lamp 308 through wiring not shown for simplification. A motor and logic power supply 430 provides power to operate the electronics and motors such as motors 600a, 600b, 602, 604, 606 and 608 as well as pan and tilt motors not shown for simplification. A motor control system 432 provides the driving signals to the motors 600a, 600b, 602, 604, 606 and 608 as well as pan and tilt motors over wiring not shown for simplification. A communications port 460 receives commands via a connection point 410 to a standard theatrical communication system. A central controller as used in the art (not shown for simplification) compatible with the DMX theatrical protocol can send commands to the communication port 460 to alter the states of the lenticular homogenizing lens 230 and the prism apparatus 350. The communications port 460 can receive the DMX commands and the commands can be passed to a processing system, processor, or microprocessor 416 that works under control of an operating system stored in a memory 415. The processor may be programmed by the operating system and/or a computer program to execute functions in accordance with an embodiment of the present invention. A display 404 driven by a display driver 420 and input buttons 402a, 402b, 402c and 402d can be used by a technician to set a unique address for the theatrical light 100.

A first command received by the theatrical light 100 can change the position of the radial lenticular lens 230 in relation to the polymer Fresnel output lens 240 to zoom the light path exiting the theatrical light 100 from narrow to wide. A second command received by the theatrical light 100 can tilt in or out each of the radial lenticular lens 330 halves 330a and 330b to be in out of the light path like that shown in FIG. 3B and 3C. A third command can place the prism apparatus 350 of FIG. 3C to be in or out of the light path of the light created by the lamp 308 and the reflector 310. A fourth command can change the position of the prism apparatus 350 in relation to the polymer fresnel output lens 240 to be closer or further away from the polymer fresnel output lens 340 of FIG. 3D to adjust the angular deviation of the second and third light paths created by the prism apparatus 350. A fifth command can cause the motor 604 to rotate the prism apparatus 350 in the path of light created by the lamp 308 and the reflector 310 to cause the second and third light paths to rotate about each other.

We claim:

1. A theatre lighting apparatus comprising:
a base;
a communications port;
a processor;
a memory;
a lamp housing;
the lamp housing comprising;
a lamp,
a reflector,
an output lens,
a motor,
and a homogenizing lens;
wherein the homogenizing lens is comprised of a plurality of radially arranged lenticular lenses;
and wherein the processor is controlled by an operating system stored in the memory to cause the motor to change a distance between the homogenizing lens and the output lens.

2. The theatre lighting apparatus of claim 1
wherein the communications port receives a command, provides the command to the processor, and the processor in response to the command is programmed to cause the motor to change the distance between the homogenizing lens and the output lens.

3. The theatre lighting apparatus of claim 1
wherein the output lens is a polymer fresnel lens.

4. The theatre lighting apparatus of claim 1 wherein
the lamp and the reflector are configured to produce a first light having a first light path having an optical axis;
and further comprising a prism, where there is an optical axis between the prism and the output lens;
and further comprising a means for changing a distance along the optical axis between the prism and the output lens, while the prism is in the first light path.

5. The theatre apparatus of claim 4 wherein
the first light having the first light path enters the prism and causes a second light having a second light path to exit the prism;
wherein the first light path is at a deviation angle with respect to the second light path; and
wherein the means for changing the distance between the prism and the output lens, causes the deviation angle to change.

6. A method comprising:
using a processor controlled by an operating system stored in memory to cause a motor to change a distance between a homogenizing lens and an output lens in a theatre lighting apparatus;
wherein the theatre lighting apparatus includes
a base;
a communications port;
the processor;
the memory;
a lamp housing;
the lamp housing comprising;
a lamp,
a reflector,
the output lens,
the motor,
and the homogenizing lens; and
wherein the homogenizing lens is comprised of a plurality of radially arranged lenticular lenses.

7. The method of claim 6 further comprising
receiving a command at the communications port;
providing the command to the processor, and
causing the processor in response to the command to cause the motor to change the distance between the homogenizing lens and the output lens.

8. The method of claim 6 wherein
wherein the output lens is a polymer fresnel lens.

9. The method of claim 6 wherein
the lamp and the reflector are configured to produce a first light having a first light path having an optical axis;
and wherein the theatre lighting apparatus includes a prism; and
and further comprising changing a distance along an optical axis between the prism and the output lens, while the prism is in the first light path

10. The method of claim 9 wherein
the first light having the first light path enters the prism and causes a second light having a second light path to exit the prism;
wherein the first light path is at a deviation angle with respect to the second light path; and
wherein the step of changing the distance between the prism and the output lens, causes the deviation angle to change.
